(19) United States
(12) Patent Application Publication
(10) Pub. No.: US 2009/0242750 A1
(43) Pub. Date: Oct. 1, 2009

(54) PROTEIN PURIFICATION AND IDENTIFICATION

(75) Inventors: Johan Axelman, Sollentuna (SE); Daniel Ivansson, Uppsala (SE); Staffan Renlund, Uppsala (SE)

Correspondence Address: GE HEALTHCARE BIO-SCIENCES CORP.;PATENT DEPARTMENT, 800 CENTENNIAL AVENUE, PISCATAWAY, NJ, 08855, US

(73) Assignee: GE HEALTHCARE BIO-SCIENCES AB, UPPSALA (SE)

(21) Appl. No.: 12/302,381

(22) PCT Filed: Jun. 8, 2007
(86) PCT No.: PCT/SE2007/000553

§ 371 Date: Nov. 25, 2008

(30) Foreign Application Priority Data
Jun. 30, 2006 (SE) 0601460-9

(51) Int. Cl. H01J 49/26; B01D 59/44

(52) U.S. Cl. 250/282

(57) ABSTRACT

The present invention relates to a method for protein purification and identification. More closely the invention relates to a method for protein pre-fractionation and identification resulting in improved yield of identified proteins. The method for pre-fractionation of protein samples, includes the following steps: a) reducing disulphide bridges (S-S bridges) or protecting cysteines in the proteins in the sample; b) loading the sample onto an ion exchange column; c) eluting the sample; d) collecting each fraction from the column separately in air sealed containers devoid of chromatographic media; e) desalting each fraction on a single RPC (reversed phase chromatography) trap column; f) separating each fraction in a second dimension RPC step to obtain further separated proteins which are collected in fractions; and g) identifying the further separated proteins by MS.

### CROSS-REFERENCE TO RELATED APPLICATIONS

This application is a filing under 35 U.S.C. § 371 and claims priority to international patent application number PCT/SE2007/000553 filed Jun. 8, 2007, published on Jan. 3, 2008, as WO 2008/002235, which claims priority to patent application number 0601460-9 filed in Sweden on Jun. 30, 2006.

### FIELD OF THE INVENTION

The present invention relates to a method for protein purification and identification. More closely the invention relates to a method for protein pre-fractionation and identification resulting in improved yield of identified proteins.

### BACKGROUND OF THE INVENTION

Within the field of proteomics several approaches have been made to characterize the proteome, i.e. the expressed proteins. Two dimensional gel electrophoresis followed by in-gel digestion of proteins and MS and MS/MS analysis has for many years been the method of choice despite the laborious work flow. The so called shot gun/multidimensional protein identification technology (MudPIT) approach offered considerable automation and simplification in combination with speed and some improvements in protein identification efficiency. This method starts with a global digestion of all the proteins of the entire proteome into smaller peptides, normally by using trypsin. The peptide mixture is then analyzed using a one-step combination of step-gradient ion exchange chromatography and reversed phase chromatography. Today, such two dimensional liquid chromatography (2DLC) on the peptide level, also known as “bottom-up” proteomics has reached broad acceptance on samples with moderate complexity.

However, the drawback with this shotgun approach is that starting with a total protein digestion, not only does the level of sample complexity increase dramatically; the correlation to the proteins from which the peptides are derived is lost. Also, if samples are more complex or if the sample is contaminated with a very prominent protein, e.g. albumin in plasma or serum, a straight forward method as MudPIT and 2DLC on peptide level is no longer sufficient in order to fractionate the sample in such a way that subsequent MS analysis can successfully identify and characterize the involved proteins.

For that reason it is essential to start the separation on the basis of whole proteins and not at peptide level alone.

Another approach has therefore been to start with proteins and fractionate these into manageable fractions. The addition of such multidimensional chromatography (MDLC) for protein-pre-fractionation of intact proteins prior to tryptic digestion in the LC-MS workflow not only reduces sample complexity and dynamic range and enhances the possibilities of a comprehensive identification of proteins; it also adds the possibility to separate between protein isoforms. Distinguishing between isoforms is important in order to detect and develop specific biomarkers and build the understanding of biological processes regarding for example cancer.

However, despite the high peak capacity of MDLC and potential of resolving 1000-2000 tryptic peptide peaks by UV-monitoring, data base search results and protein identification numbers are generally relatively disappointing with a few hundred up to about a thousand proteins identified, depending on the complexity and dynamic range of the sample, e.g. bacterial, yeast or human.

The number of identified proteins in E. coli have been compared using the Shotgun approach, essentially as described by Washburn et al (2001) and modified by Axelman et al (2004a) on the one hand and protein pre-fractionation (PPF) of intact proteins before digestion and MS/MS on the other hand (Axelman et al 2004b; Höpker et al 2005). E. coli lysate proteins were digested and analyzed according to the modified shotgun approach, i.e. the sample was subjected to a global digestion and then analyzed by “Offline MDLC” (GE Healthcare, Sweden) and LTQ MS/MS (Thermo Finnigan, USA). In the PPF approach, the intact E. coli sample was separated in a first dimension using anion exchange chromatography (AIEX), fractions stored on reversed phase chromatography (RPC) trap columns packed with silica C4 media and after desalting separated in a second dimension using RPC with silica C4 media. The collected fractions were dried and digested with trypsin and then analyzed using MDLC LTQ MS/MS.

The shotgun technique and the described protein pre-fractionation technique give about the same yield with respect to the number of identified proteins by MS/MS. I.e., the results showed 452 unique proteins identified by the shotgun approach and 547 unique proteins identified using the PPF approach, representing about 12-15% of the maximum expected expression of the proteome.

Thus, it would be desired to have modified methods for protein pre-fractionation to improve the yield of protein identification in MS/MS.

### SUMMARY OF THE INVENTION

The present invention provides such an improved method for pre-fractionation of proteins.

Thus, the invention relates to a method for protein pre-fractionation, comprising the following steps:
a) reducing disulphide bridges (S-S bridges) or protecting the cysteines in the proteins in the sample;
b) loading the reduced or protected sample onto an ion exchange column;
c) eluting the sample;
d) collecting each fraction from said column separately in air sealed containers devoid of chromatographic media;
e) desalting each fraction on a single RPC (reversed phase chromatography) trap column;
f) separating each fraction in a second dimension RPC step to obtain further separated proteins which are collected in fractions; and
g) identifying the further separated proteins by MS.

The sample may be any sample comprising proteins of any origin.

When a reducing agent is used in step a) then the column in step b) is preferably equilibrated with the same reducing agent and the elution in step c) is preferably done in the presence of a reducing agent. Alternatively in step a), the cysteines are protected such as by alkylation or thiol disulphide exchange, for example by using DESTREAK™.

Preferably, the ion exchange media used in step b) is a small bead size ion exchange chromatography media, such as MINI Q™, or other small bead size (3-5 μm) ion exchange chromatography stationary phase with a similar high resolving power.

Preferably, the air sealed containers are tubings or loops of appropriate volume, or tubes with air tight capping.

The RPC media in e)-f) is preferably a polymer chromatography stationary phase compatible with high pH (>pH 8), such as SOURCE™ 5 RPC.

For identification the proteins may be digested before MS. Digested proteins are preferably analyzed and identified by means of MS/MS. Intact proteins, which are not digested, are preferably analyzed and identified by means of fourier transform (FT) MS and/or FT-MS/MS or a mass spectrometry technique with a similar high mass resolving power and mass detection accuracy.

The method comprises the following steps in a preferred embodiment:
a) Arranging cation exchange and anion exchange chromatography columns in a tandem configuration by a serial coupling
b) reducing the proteins in the sample by treatment with a reducing agent, e.g. dithiothreitol
c) loading the reduced sample onto the ion exchange columns packed with small bead size ion exchange chromatography media, such as MINI Q™, or other small bead size (3-5 μm) ion exchange chromatography stationary phase with a similar high resolving power, or, if considered sufficient for the separation, to just one of the columns, after having disconnected the one which is not needed
d) eluting the sample in an appropriate gradient (stepwise or linear) with an appropriate buffer, e.g. containing Tris, urea and iso-propanol and containing the said reducing agent
e) collecting each fraction from said column(s) separately in air sealed containers, such as capillary tubings of appropriate volume, so called loops, or tubes with air tight capping
f) desalting each fraction on one separate RPC trap column packed with a polymer RPC stationary phase, e.g. SOURCE™ 5RPC
g) separating each fraction in a second dimension chromatography step by reversed phase chromatography on a RPC column packed with a polymer RPC stationary phase, e.g. SOURCE™ 5RPC to obtain further separated proteins which are collected in fractions,
h) drying the collected fractions and digesting the separated proteins, and
i) identifying the further separated proteins by MS/MS.

### BRIEF DESCRIPTION OF THE DRAWINGS

FIG. 1 shows a comparison of different identification results. The histogram staples show the number of proteins identified by X!Tandem search engine, expectation value=0.01.

The first staple, named “Shotgun”, shows the result (457 identified proteins) of the modified shotgun approach (Axelman et al 2004a).

The second staple, named “PPF Prior Art” shows the result (452 identified proteins) of the PPF approach using a method described in Axelman et al. (2004b). The method used and the resulting total number of identified proteins are comparable to other published results. 142 fractions were analyzed with LC-MS/MS.

The third staple, named “PPF Present Invention: Subset analyzed” shows the result (1068 identified proteins) of the PPF approach according to the present invention. This figure is based on LC-MS/MS analysis of 70 randomly collected fractions out of a total number of 328.

The last staple, named “PPF Present Invention: Total Estimated” shows result (˜3500 identified proteins) of the PPF approach according to the present invention after extrapolation of the results from the LC-MS/MS analyzed subset of 70 fractions to all 328 fractions.

### DETAILED DESCRIPTION OF THE INVENTION

### 1. First Dimension (IEX) Running Conditions

(a) By reducing the sample and using reducing conditions (DTT) during separation the total protein yield was improved by ˜50%.
(b) A tandem approach (e.g. SAX-SCX or SCX-SAX) showed very little advantage for analysis of the E. coli sample—just about 2.6% (SAX-SCX) or 5.7% (SCX-SAX) of the total protein amount was bound to SCX. However, the tandem approach may be more advantageous when analyzing more complex samples, e.g. samples of human origin.
(c) MINIBEADS™ (MINI Q™) proved to have a superior resolution compared to MONOBEADS™ (MONO Q™) and increased the peak capacity about 100% by reducing the peak width to about half compared to using MONOBEADS™.

### 2. First to Second Dimension Storage Conditions

Storage of the first dimension (AIEX) fractions in loops and desalting the stored fractions on a trap column immediately before RPC separation resulted in a ˜100% improvement in total protein yield as compared to long term storage on trap columns.

### 3. Second Dimension (RPC) Running Conditions

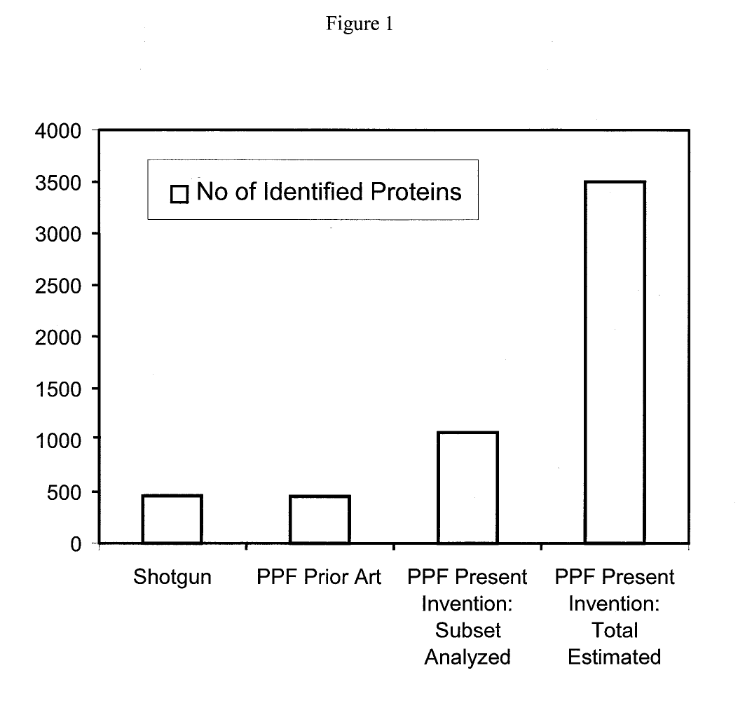

The use of polymer stationary phase (SOURCE™ 5RPC) for the second dimension chromatography instead of silica based RPC increased the recovery as monitored by UV significantly and the number of identified proteins (FIG. 1).

### EXAMPLES

Below the present invention will be disclosed by way of examples, which are intended solely for illustrative purposes and should not be construed as limiting the present invention as defined in the appended claims. All references mentioned below or elsewhere in the present application are hereby included by reference.

### Material and Methods—PPF

ETTAN™ LC (GE Healthcare, Sweden) was equipped with extra valves and software to allow automatic 2D/PPF operation.

### 1st Dimension PPF-Anion Exchange Chromatography (AIEX)

Sample: ˜2.5 mg E. coli protein (BioRad) dissolved in Eluent A and reduced by heating to 37° C. for 90 min
Column: MINI Q™ 5/50 (5×50 mm, GE Healthcare, Sweden).
Eluent A: 20 mM Tris in 6% isopropanol and 8 M Urea, 10 mM dithiothreitol, pH 8.5,
Eluent B: 20 mM Tris in 6% isopropanol and 8 M Urea, 10 mM dithiothreitol with 1 M NaCl, pH 8.5.
Gradient: 0% for 16 min; 0-17% B over 20 min; 17-100% B over 15 min
Flow rate: 0.5 ml/min
UV-detection: 280 nm
Fractionation: Every 2 min in 4 ml loops by PEEK tubing
   Desalting and buffer exchange
Column: SOURCE™ 5RPC 4.6×10 mm, GE Healthcare, Sweden
Eluent A: 0.065% TFA.
Eluent B: 0.050% TFA in 84% acetonitrile.
Gradient: 0% B for 3 loop volumes
Flow rate: 0.5 ml/min
UV-detection: 215 nm

Sample was transferred from loop to trap-column and desalted in one step.

Transfer/Desalting was performed by 3 column volumes at 2 ml/min (loop 1: 18 min, loops 2-21: 6 min). The flow was then lowered to 0.5 ml/min before RPC fractionation.

### 2nd Dimension PPF-Reversed Phase Chromatography (RPC):

Column: SOURCE™ 5RPC 4.6×150 mm, GE Healthcare, Sweden
Eluent A: 0.065% TFA.
Eluent B: 0.050% TFA in 84% acetonitrile.

Gradient: 0-25% B in 0.1 min, 25-75% B in 84 min, 75-100% in 10 min.
Flow rate: 0.5 ml/min
UV-detection: 215 nm
Fractionation: 1 ml fractions in microtiter plates with 2 ml wells

It is understood that the invention, as described in its different aspects, is not limited to the described samples, buffer compositions, elution gradients and flow rates as described above in Materials and Methods.

### Digestion and Treatment of Fractions Pre MS/MS

1. The vial content pipetted to Eppendorff tubes
2. Fractions dried in speed vacuum over night (heating turned off-equal to ca +30° C. in the vacuum chamber)
3. To each vial added: 10 μl 6 M Guanidine HCL
4. Vortex quickly with a low grip to keep wettening of tube walls as low as possible
5. Add 1 μl 250 mM DTT (to give a final concentration of 23 mM)
6. Vortex quickly with a low grip to keep wettening of tube walls as low as possible
7. Leave at room temperature 1 h
8. Add 3 μl 850 mM iodacetamide (to give a final concentration of 182 mM-IAM must be >6× access of DTT because of dual thiol groups in DTT)
9. Vortex quickly with a low grip to keep wettening of tube walls as low as possible
10. Leave in dark place 1 hour at room temperature
11. Add 65 μl 50 mM NH₄HCO₃ (to give <1 M GUA which is trypsin compatible)
12. Vortex quickly with a low grip to keep wettening of tube walls as low as possible
13. Add 1 μl 0.25 μg/μl trypsin (to give ca 1:30 enzyme:substrate ratio)
14. Leave at 37° C. over night
15. Add 1.5 μl concentrated formic acid to give ca pH 2.5
16. Vortex quickly with a low grip to keep wettening of tube walls as low as possible
17. Transfer the digested sample to AS-vilas and analyze ASAP. Leave vials on AS-cooled peltier plate

### MDLC/LTQ Run Conditions

RPC trap 300 μm i.d., 5 mm (Zorbax SB-300, C18, 3 μm, 100 Å)

RPC analytical column 75 μm i.d., 150 mm (LCpackings Pep map, C18, 3 μm, 100 Å)

Mobile phase A was 0.1% formic acid and B 84% acetonitrile and 0.1% formic acid.

Gradient: 0-37.5% B in 90 minutes.

Flow rate: 100 ul/min, splitted flow ˜300 nl/min

LTQ linear ion trap

3 Scan events: 1: Full scan; 2: Zoom scan; and 3: MS/MS

Event 2 and 3 repeated for top 3 peaks from scan event 1.

Dynamic exclusion activated

### Results

The novel PPF system according to the invention has unique features of protein pre-fractionation: Reduction of sample complexity, expansion of the dynamic range and maintenance of intact proteins throughout the separation, making it possible to analyze particular identified proteins further by tracking the fraction(s) where they are collected. The PPF method leads to the following improvements compared to prior art:
1. 50% increased recovery due to reduced buffer conditions (DTT in buffers and sample)
2. 100% increased recovery due to storage in loops instead of on RPC trap columns.
3. 100% increased peak capacity due to MINIBEADS™ instead of MONOBEADS™ in the 1st dimension chromatography
4. 100% increase in number of identities due to SOURCE™ 5 RPC media instead of silica

The E. coli proteome was analyzed with the novel PPF approach according to the invention and the result was about 3500 identified unique proteins (96% of the maximum expected) (FIG. 1). This result is 3-7 times better than what is generally achieved using the Shotgun approach.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method for pre-fractionation of protein samples, comprising the following steps:
a) reducing disulphide bridges (S-S bridges) or protecting cysteines in the proteins in the sample;
b) loading the sample onto an ion exchange column;
c) eluting the sample;
d) collecting each fraction from said column separately in air sealed containers devoid of chromatographic media;
e) desalting each fraction on a single RPC (reversed phase chromatography) trap column;
f) separating each fraction in a second dimension RPC step to obtain further separated proteins which are collected in fractions; and
g) identifying the further separated proteins by MS.

2. The method of claim 1, wherein a reducing agent is used in step a) and the column in step b) is equilibrated with a reducing agent and the elution in step c) is in the presence of a reducing agent.

3. The method of claim 1, wherein the ion exchange media is small bead size ion exchange chromatography media.

4. The method of claim 1, wherein the air sealed containers are tubings or loops of appropriate volume, or tubes with air tight capping.

5. The method of claim 1, wherein the RPC media in e)-f) is a polymer chromatography stationary phase compatible with high pH (>pH8).

6. The method of claim 1, wherein the proteins are digested before MS.

7. The method of claim 6, wherein step g) is MS/MS.

8. The method of claim 1, wherein step g) is FT-MS or FT-MS/MS.
